(19) United States
(12) Patent Application Publication
(10) Pub. No.: US 2003/0024767 A1
(43) Pub. Date: Feb. 6, 2003

(54) Climbing treestand

(76) Inventor: Michael H. Lane, Canton, GA (US)

Correspondence Address: Robert B. Kennedy, Baker, Donelson, Bearman & Caldwell, Five Concourse Parkway, Suite 900, Atlanta, GA, 30328, US

(21) Appl. No.: 09/922,268

(22) Filed: Aug. 6, 2001

(51) Int. Cl. A01M 31/00

(52) U.S. Cl. 182/136; 182/187

(57) ABSTRACT

Bubble levels are mounted to the seat and base sections of a climbing treestand so that the x and y axes level status of both may be viewed simultaneously in use.

### TECHNICAL FIELD

This invention relates generally to treestands that are usually used by hunters, and particularly to climbing treestands.

### BACKGROUND OF THE INVENTION

Treestands fall generally into three types. Firstly there is the fixed type of stand that is attached to a tree as with T-bolts. Secondly there is the ladder type stand that is leaned against a tree. Then there is the climbing type treestand which is the least environmentally intrusive type and which is particularly favored by bow hunters.

Climbing treestands have two structurally independent sections, namely, an upper, hand climber section with a seat and a lower base section with a platform. Each section has a cable, chain or bar that is looped around the tree. In use the stand and hunter mount and descend the tree together much like an inch worm moves. To do this the hunter puts his boots in stirrups or straps attached to the top of the base platform after having looped the base cable around the tree. With the seat cable also looped around the tree above the base, he raises the seat to eye level or above and then pulls down on the seat. This cocks the seat causing its edge adjacent to the tree to bite it as the cable becomes taut. The hunter then raises the base with his feet thereby bending his knees and then loads it causing it to cock and become secured. This process is repeated over and over until the hunter has reached the desired height.

Once at the desired height the hunter may sit upon the seat with his feet upon the base platform, preferably wearing a safety strap looped around the tree. Should game such as a deer appear he can stand up upon the platform to shoot. When finished the hunter descends with the climbing deer stand in the reverse order of stand maneuvers.

Though climbing treestands have been used before rather extensively, they have been hard to set in a proper orientation once the hunter has reached the desired height. Thus hunters have found that the seat may be tilted or cocked off axis as may be the platform. Indeed, one section may lean to the left and the other to the right which aggravates the problem. Thus it is the principal object of the present invention to eliminate this problem of orientation of climbing treestands.

### SUMMARY OF THE INVENTION

In a preferred form of the invention a climbing treestand comprises a base having a platform with a wrap cable and with a seat level. The base level and seat level are respectively mounted to the base and seat in positions to be simultaneously viewed from above.

### BRIEF DESCRIPTION OF THE DRAWING

FIG. 1 is a side view, in perspective, of a climbing treestand that embodies principles of the invention in its preferred form.

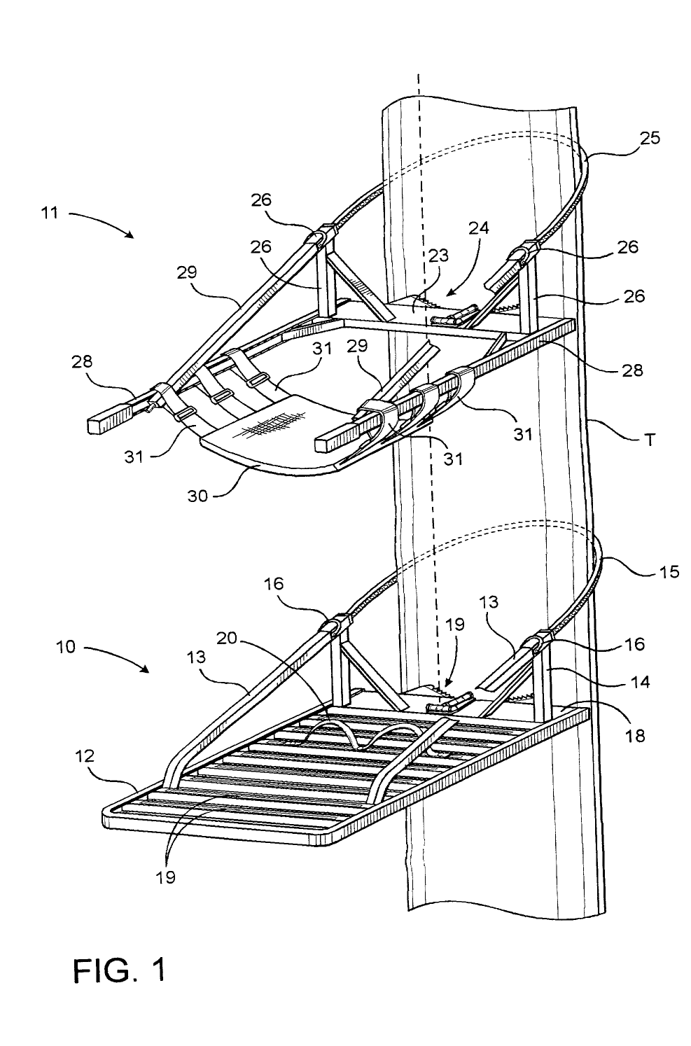

FIG. 2 is a top view, in perspective, of the treestand shown in FIG. 1, the stand being shown in both figures in the same orientation.

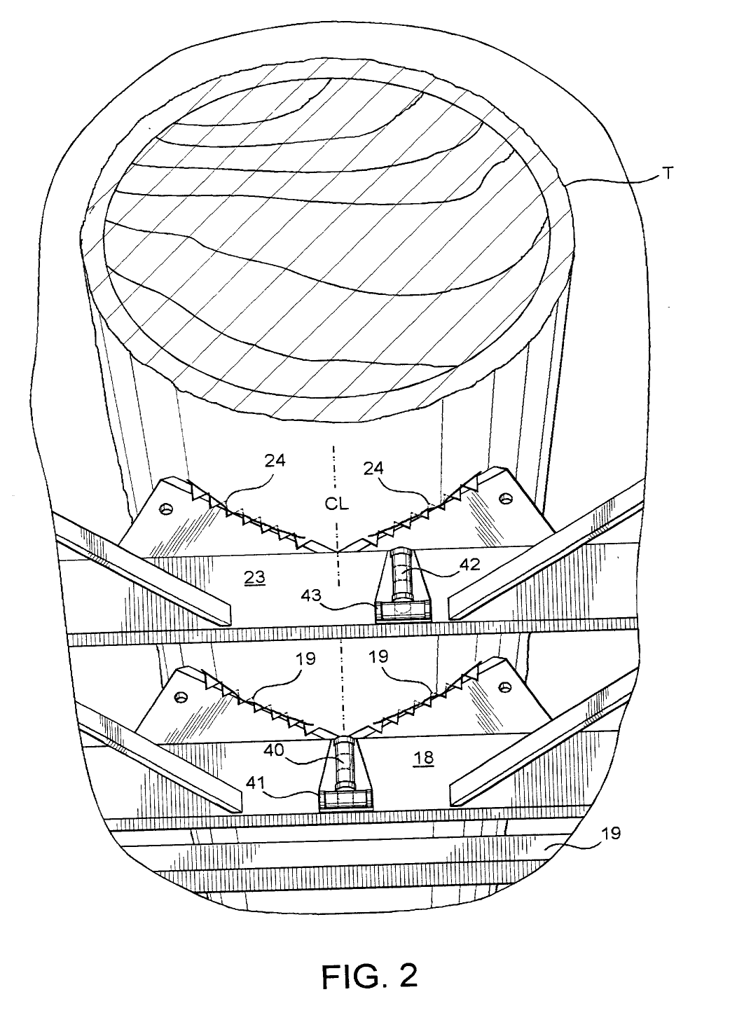

### DETAILED DESCRIPTION

Referring now in more detail to the drawing, there is shown a climbing treestand having a base 10 and a seat 11. The base has a multi rung platform 12 with channel-shaped side rails 13 that extend to two upright posts 14. A sheathed cable 15 extends from the top of one post to the other and is releasibly held within the channels of the side rails by lock pins 16 which can be extended through any one of a number of transverse holes in end portions of the sheathed cable. The rear end of the platform has a slat 18 that is coplanar with the rungs 19. The posts 14 are mounted atop this slat. The rear of the slat has a V-shape jaw with serrated teeth. Finally, a strap 20 is secured atop the platform to provide a stirrup into which the boots or shoes of a hunter may be inserted. The stand is of sturdy metal structure.

The seat 11 also has a slat 23 formed with a V-shaped, serrated jaw 24. A sheathed cable 25 extends between the tops of two posts 26 mounted uprightly on the slat. Again the cable is adjustable in length by locating lock pins 26 within different transverse holds in the cable. Two arms 28 extend from the slat 23 which are supported by two side rails 29. A seat 30 is mounted to the arms 28 by straps 31.

Cross check bubble levels are mounted to the base section and to the seat sections. More specifically, two bubble levels are mounted to both the base and to the seat. A pitch bubble level 40 is mounted along the center line (CL) of the base slat 18 and the center line of the V-shaped jaw 19. A tilt bubble level 41 is also mounted transversely across this center line at the distal end of level 40 from the jaw. A pitch bubble level 42 is mounted upon the seat slat 23 offset from the slat and jaw center line. A tilt bubble level 43 is also mounted to slat 23 at the distal end of level 42. The level 40 is oriented right angularly to level 41. Similarly, level 42 is oriented rightly angularly to level 43. The base and seat levels thus provide x-y axes level indications for both sections of the stand.

As a hunter reaches his desired height he may look down on the four levels simultaneously. Should the base not be level he can adjust its orientation until both base levels 40 and 41 indicate a level state. He then can do the same with the seat section. Now when he sits down or stands he will do so with both units level.

It thus is seen that a climbing treestand is now provided that alleviates a major safety and comfort problem that has long existed with conventional stands. Though the preferred embodiment uses cables looped about a tree, it should be understood that chains and bars are also often used and thus are considered as being equivalents herein. Also, there are treestands that have a foldable seat mounted to the base section instead of to the hand climber section. Although the invention has been shown and described in its preferred form, it should be understood that many modifications, changes or additions may be made thereof without departure from the spirit and scope of the invention as set forth in the following claims.

1. A climbing treestand comprising a base having a platform with a wrap around tree cable and a base level upon which a hunter may stand, and a seat having a wrap around tree cable with a seat level, said base level and said seat level being respectively mounted to said base and seat in positions to be simultaneously viewed from above.

2. The climbing treestand of claim 1 wherein said base level and said seat level are each comprised of a bubble level.

3. The climbing treestand of claim 2 wherein said base level and said seat level are each comprised of two bubble levels oriented at substantially right angles to each other.

4. The climbing treestand of claim 3 wherein said base further comprises a generally V-shaped, tree engaging serrated jaw, and wherein one of said two base bubble levels is oriented along a line that bisects said base V-shaped jaw.

5. The climbing treestand of claim 4 wherein said seat further comprises a generally V-shaped, tree engaging serrated jaw, and wherein one of said two base bubble levels is oriented spaced from and parallel to a line that bisects said seat V-shaped jaw.

6. A climbing treestand comprising a base having a platform with a tree engaging edge, a wrap around tree cable, and x-y axes level means for viewing the degree of level of said platform along two intersecting axes, and a hand climber having a tree engaging edge and a wrap around tree cable, said hand climber being structurally independent of said platform.

7. The climbing treestand of claim 6 wherein said hand climber has an x-y axis level means for viewing the degree of level of said seat along two intersecting axes.

8. The climbing treestand of claim 7 wherein said hand climber level means and said base level means are mounted respectively to said seat and base for simultaneous viewing from above.

9. The climbing treestand of claim 6 wherein said hand climber has a seat.
